(19) United States
(12) Patent Application Publication
(10) Pub. No.: US 2020/0059775 A1
(43) Pub. Date: Feb. 20, 2020

(54) SOS and TAG

(71) Applicant: Godwin E. Enogieru, Dallas, TX (US)

(72) Inventor: Godwin E. Enogieru, Dallas, TX (US)

(21) Appl. No.: 16/104,877

(22) Filed: Aug. 18, 2018

(51) Int. Cl. H04W 4/90; G06F 17/30

(52) U.S. Cl. CPC H04W 4/90; G06F 17/30884

(57) ABSTRACT

The present invention relates generally to App feature that can be pushed, and the system will initiate a 911 number and the 911 is called in case of emergency should they be any problem during the ride. Also TAG Favorite Driver unique feature krooz customers or rider can easily tag a driver he or she deemed as a favorite driver.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

This invention relates generally to process management and more particularly to feature display on krooz customer app for emergency and safety purpose. Another unique feature krooz customers or rider can easily tag a driver he or she deemed as a favorite driver.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

In order to solve the above problems, the present invention is App that feature display on krooz customer app for emergency and safety purpose, and on krooz driver app, a feature that can be pushed, and the system will initiate a 911 number and the 911 is called in case of emergency should they be any problem during the ride. This SOS feature is available both on the krooz app and krooz driver app.

Yet still another object of the system consists of several modules which can be combined in numerous ways, and which are variously designed to operate on computers, mobile devices, other electronic devices that may become available in the future, on private networks, and on servers reached through browsers or other means.

With the TAG Favorite Driver unique feature krooz customers or rider can easily tag a driver he or she deemed as a favorite driver. When the TAG is generated on the krooz customer app it will trigger the krooz driver app back-end functionality and whenever a ride request is generated by the customer, the driver that is being tagged by that customer/rider will receive the ride request first as priority. The ‘Tag favorite driver’ feature is located on the krooz app and krooz driver app.

It is therefore an object of the present invention to provide such a system which makes things convenient.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is a schematic illustration of the app design.

FIG. 200 shows another view once the ride is requested.

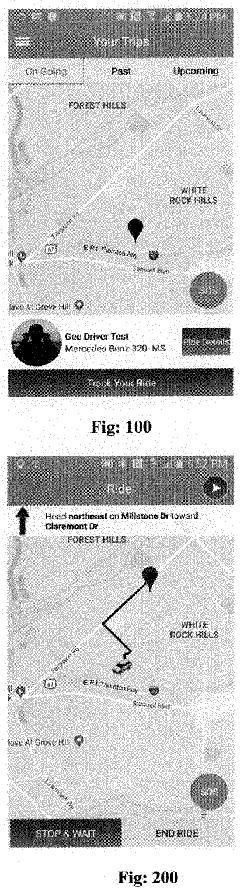

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description.

The proposed invention is a unique krooz apps feature display on krooz customer app for emergency and safety purpose, and on krooz driver app, a feature that can be pushed, and the system will initiate a 911 number and the 911 is called in case of emergency should they be any problem during the ride. This SOS feature is available both on the krooz app and krooz driver app.

Another feature is TAG Favorite Driver unique feature krooz customers or rider can easily tag a driver he or she deemed as a favorite driver. When the TAG is generated on the krooz customer app it will trigger the krooz driver app back-end functionality and whenever a ride request is generated by the customer, the driver that is being tagged by that customer/rider will receive the ride request first as priority. The ‘Tag favorite driver’ feature is located on the krooz app and krooz driver app.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1-2: (canceled)

3: a mobile application with a safety button to be pressed by user in-case of emergency once the ride is booked.

4: favorite driver will receive the ride request first on priority.
